(19) United States
(12) Patent Application Publication
(10) Pub. No.: US 2010/0314041 A1
(43) Pub. Date: Dec. 16, 2010

(54) METHOD OF MAKING A MULTILAYER SUBSTRATE WITH EMBEDDED METALLIZATION

(75) Inventors: Sum Huan Ng, Singapore (SG); Zhenfeng Wang, Singapore (SG)

Correspondence Address: Altera Law Group, LLC, 220 S 6 St Suite 1700, Minneapolis, MN, 55402, US

(73) Assignee: Agency for Science, Technology and Research, Connexis (SG)

(21) Appl. No.: 12/867,327

(22) PCT Filed: Feb. 16, 2009
(86) PCT No.: PCT/SG09/00050

§ 371 Date: Aug. 12, 2010

Related U.S. Application Data
(60) Provisional application No. 61/064,179, filed on Feb. 20, 2008.

(51) Int. Cl. B32B 38/00; B05D 5/12

(52) U.S. Cl. 156/278; 427/58

(57) ABSTRACT

A method of making a substrate includes providing an upper insulative layer and a lower insulative layer, wherein the upper insulative layer includes an inlet opening, the lower insulative layer includes a channel, and the inlet opening is in fluid communication with the channel, flowing a non-solidified material through the inlet opening into the channel, and then solidifying the non-solidified material by applying energy to the non-solidified material, thereby forming embedded metallization in the channel. The substrate can be a microfluidic device, an electrical interconnect or other electronic devices.

### CROSS-REFERENCE TO RELATED APPLICATIONS

This application claims priority from U.S. Provisional Application Ser. No. 61/064,179 filed Feb. 20, 2008.

### FIELD OF THE INVENTION

The present invention generally relates to substrate manufacture, and more particularly to a method of making a multilayer substrate with embedded metallization.

### BACKGROUND OF THE INVENTION

Multilayer substrates with embedded metallization are used in a wide variety of applications such as microfluidic devices and electrical interconnects.

Microfluidic devices are small compact devices that perform chemical and physical operations such as capillary electrophoresis with microscale sample volumes, fast reactions, rapid detection, ease of automation and simple transfer between reaction vessels. Microfluidic devices are also referred to as “lab-on-a-chip”.

Electrophoretic separation of bio-molecules is critically important in modern biology and biotechnology techniques such as DNA sequencing, protein molecular weight determination, genetic mapping and the like. Electrophoresis separates individual molecular species in a solution by applying an electric field. The charged molecules migrate through the solution in the electric field and separate into distinct bands due to their different rates of movement through the solution. The rates are influenced by the pH of the solution, the mass and charge of the molecules, and the strength and duration of the electric field.

Electrical interconnects provide high-density electrical connections between semiconductor chips that must communicate with one another economically and reliably. For instance, copper/polyimide substrates contain buried wiring patterns to conduct electrical signals between the chips. These interconnects usually contain multiple layers of interconnect metallization separated by alternating layers of an isolating dielectric to provide electrical isolation between the metallization. Electrical interconnects are also referred to as interconnect substrates, printed circuit boards and multi-chip modules.

Semiconductor chips continue to evolve at a phenomenal rate. As a result, electrical interconnects often provide not only signal routing, but also circuit signal matching, thermal management, mechanical support, and electrical functionality.

Conventional multilayer substrate manufacture typically provides metallization on a lower insulative layer, then laminates an upper insulative layer to the lower insulative layer and metallization. Thereafter, additional metallization is provided on the upper insulative layer and in vias between the insulative layers to connect the multi-level metallization.

For example, conductive traces are deposited on a polymer layer by sputtering, screen printing, microjetting, hot stamping or electroplating. Photolithography is often used to pattern the traces. Thereafter, the process is repeated for another layer, and so on. Plated through-holes are subsequently formed by drilling through the substrate and plating metal in the holes to connect the multi-level traces. As another example, thin metal foils are attached to opposite sides of a polymer layer, the metal foils are patterned using photolithography, and then the plated through-holes are formed.

Conventional substrate manufacturing has numerous drawbacks. As the number of layers increase, so does the number of metallization and lamination steps. The metallization is difficult to form with a high aspect ratio and differing thickness, and is especially difficult to form in embedded cavities. Lamination is difficult due to the metallization topography. Plated through-holes with small diameters are prohibitively expensive. Plated through-holes also interfere with routing and the situation gets worse as layer counts increase. Blind and buried vias address through-hole limitations but require many more process steps. Photolithography leads to non-uniformity of electrolytically deposited metal, photoresist reliability problems at high aspect ratios, etching undercut, inconsistent etch rates, and numerous process steps for resist lift-off.

Therefore, there is a need for a method of making a multilayer substrate with embedded metallization that is convenient, cost-effective and versatile.

### SUMMARY

The present invention provides a method of making a substrate that includes providing an upper insulative layer and a lower insulative layer, wherein the upper insulative layer includes an inlet opening, the lower insulative layer includes a channel, and the inlet opening is in fluid communication with the channel, flowing a non-solidified material through the inlet opening into the channel, and then solidifying the non-solidified material by applying energy to the non-solidified material, thereby forming embedded metallization in the channel.

The present invention also provides a method of making a substrate that includes providing an insulative layer that includes an upper insulative layer and a lower insulative layer, wherein the upper insulative layer includes an inlet opening, the lower insulative layer includes a channel, and the inlet opening and the channel are in fluid communication with one another but not with an outlet opening, disposing the insulative layer in a vacuum chamber, evacuating the vacuum chamber, thereby creating a vacuum in the inlet opening and the channel, then flowing a non-solidified material into the inlet opening while the vacuum chamber contains the vacuum and then through the inlet opening into the channel while the insulative layer remains in the vacuum chamber, thereby flowing the non-solidified material into but not out of the insulative layer, and then solidifying the non-solidified material by applying energy to the non-solidified material, thereby forming a dead-end electrode in the channel.

The present invention also provides a method of making a microfluidic device that includes providing an upper insulative layer, a middle insulative layer and a lower insulative layer, wherein the upper insulative layer includes an inlet opening, the middle insulative layer includes a via, the lower insulative layer includes a channel, and the inlet opening, the via and the channel are in fluid communication with one another, then flowing a non-solidified material sequentially through the inlet opening, the via and the channel, and then solidifying the non-solidified material by applying energy to the non-solidified material, thereby forming embedded metallization that provides an electrode in the inlet opening, the via and the channel.

The present invention also provides a method of making an electrical interconnect that includes providing an upper insulative layer, a middle insulative layer and a lower insulative layer, wherein the upper insulative layer includes an inlet opening and an outlet opening, the middle insulative layer includes an inlet via and an outlet via, the lower insulative layer includes a channel, and the inlet and outlet openings, the inlet and outlet vias and the channel are in fluid communication with one another, then flowing a non-solidified material sequentially through the inlet opening, the inlet via, the channel, the outlet via and the outlet opening, and then solidifying the non-solidified material by applying energy to the non-solidified material, thereby forming embedded metallization that provides an electrical trace in the inlet and outlet openings, the inlet and outlet vias and the channel.

The method can include bonding the upper insulative layer to the middle insulative layer, and bonding the middle insulative layer to the lower insulative layer. For instance, the method can include bonding the upper insulative layer to the middle insulative layer using thermal diffusion, and bonding the middle insulative layer to the lower insulative layer using thermal diffusion. In this instance, the middle insulative layer contacts and is sandwiched between the upper and lower insulative layers. Alternatively, the method can include bonding the upper insulative layer to the middle insulative layer using an upper adhesive layer, and bonding the middle insulative layer to the lower insulative layer using a lower adhesive layer. In this instance, the upper adhesive layer contacts and is sandwiched between the upper and middle insulative layers, the middle insulative layer contacts and is sandwiched between the upper and lower adhesive layers, and the lower adhesive layer contacts and is sandwiched between the middle and lower insulative layers.

The method can include flowing the non-solidified material using pressure injection, vacuum suction, capillary motion, or combinations thereof. For instance, the method can include flowing the non-solidified material using pressure injection at the inlet opening and/or vacuum suction at the outlet opening. The method can also include flowing the non-solidified material while the insulative layer is disposed in a vacuum chamber. For instance, the method can include flowing the non-solidified material while pressure in the vacuum chamber remains a vacuum, or as pressure in the vacuum chamber increases from a vacuum to a predetermined pressure such as atmospheric pressure.

The method can include solidifying the non-solidified material using heat or ultraviolet radiation.

The top, middle and lower insulative layers can be plastic, ceramic or composite.

The non-solidified material can be a liquid or semi-solid material such as conductive epoxy paste or conductive ink. The conductive epoxy paste can include silver particles, gold particles, copper particles, silver coated copper particles, graphite particles, or combinations thereof. The conductive ink can be water-based or oil-based and include silver particles gold particles, copper particles, silver coated copper particles, or combinations thereof.

The embedded metallization can be an electrical trace or an electrode. Furthermore, the embedded metallization can fill the channel or form a tube in the channel.

Advantageously, the present invention can form a multi-layer substrate with embedded metallization that has fine width, a high aspect ratio, varying thickness and varying cross-sectional shape in channels, cavities, vias and openings in the insulative layers. The present invention can be performed with a single metallization step regardless of the number of insulative and metallization layers. In addition, the present invention is well-suited for a wide variety of applications such as microfluidic devices, electrical interconnects, display panels, EMI shields, antennas and other electronic devices that contain three-dimensional embedded metallization.

These and other features and advantages of the present invention will become more apparent in view of the detailed description that follows.

### BRIEF DESCRIPTION OF THE DRAWINGS

Embodiments of the present invention will now be more fully described, with reference to the drawings in which:

FIG. 1 is a cross-sectional view of an electrical interconnect in accordance with a first embodiment of the present invention;

FIGS. 2A-2D are cross-sectional views of a method of making the electrical interconnect in the first embodiment;

FIG. 3 is a cross-sectional view of an electrical interconnect in accordance with a second embodiment in the present invention;

FIGS. 4A-4D are cross-sectional views of a method of making the electrical interconnect in the second embodiment;

FIG. 5 is a cross-sectional view of a microfluidic device in accordance with a third embodiment of the present invention;

FIGS. 6A-6D are cross-sectional views of a method of making the microfluidic device in the third embodiment;

FIG. 7 is a cross-sectional view of a microfluidic device in accordance with a fourth embodiment in the present invention;

FIGS. 8A-8D are cross-sectional views of a method of making the microfluidic device in the fourth embodiment;

FIGS. 9A and 9B are cross-sectional and top plan views, respectively, of an electrical interconnect in accordance with a fifth embodiment in the present invention;

FIG. 10 is a top plan view of an electrical interconnect in accordance with a sixth embodiment in the present invention;

FIG. 11 is a top plan view of an electrical interconnect in accordance with a seventh embodiment in the present invention;

FIG. 12 is a top plan view of a microfluidic device in accordance with an eighth embodiment in the present invention;

FIG. 13 is a top plan view of a microfluidic device in accordance with a ninth embodiment in the present invention;

FIG. 14 is a top plan view of a microfluidic device in accordance with a tenth embodiment in the present invention; and

FIGS. 15A-15D are perspective views of techniques for flowing a non-solidified material into an insulative layer to subsequently provide embedded metallization in the insulative layer in accordance with the present invention.

### DETAILED DESCRIPTION OF THE INVENTION

In the following description, preferred embodiments of the present invention are described. It shall be apparent to those skilled in the art, however, that the present invention may be practiced without such details. Some of the details are not be described at length or are omitted so as not to obscure the present invention. Such details are well-known to those skilled in the art.

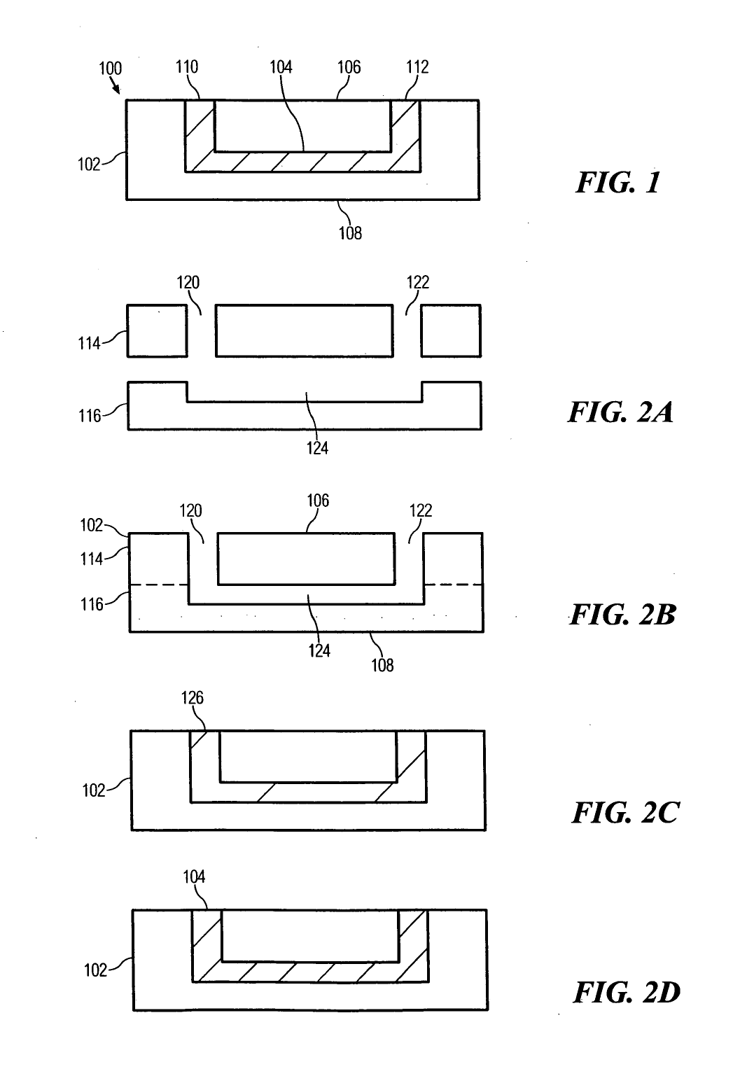

FIG. 1 is a cross-sectional view of electrical interconnect 100 in accordance with a first embodiment of the present invention. Electrical interconnect 100 includes insulative layer 102 and electrical trace 104. Insulative layer 102 is a dielectric layer, and electrical trace 104 is a routing line. Insulative layer 102 includes upper surface 106 and lower surface 108. Electrical trace 104 includes terminals 110 and 112 at upper surface 106. Thus, electrical trace 104 extends into but not through insulative layer 102. Electrical trace 104 electrically connects chips that are subsequently mounted on upper surface 106 and electrically connected to terminals 110 and 112.

FIGS. 2A-2D are cross-sectional views of a method of making electrical interconnect 100.

In FIG. 2A, upper insulative layer 114 and lower insulative layer 116 are provided. Upper insulative layer 114 includes inlet opening 120 and outlet opening 122. Inlet and outlet openings 120 and 122 extend through upper insulative layer 114 and are spaced and fluidically separated from one another. Lower insulative layer 116 includes channel 124. Upper insulative layer 114 and lower insulative layer 116 are plastic such as PMMA or polycarbonate.

In FIG. 2B, upper insulative layer 114 and lower insulative layer 116 are bonded to one another using thermal diffusion. Furthermore, inlet and outlet openings 120 and 122 are aligned with opposite ends of channel 124. Thus, inlet and outlet openings 120 and 122 and channel 124 are in fluid communication with one another. Furthermore, insulative layers 114 and 116 form insulative layer 102. Thus, upper insulative layer 114 provides upper surface 106, and lower insulative layer 116 provides lower surface 108.

In FIG. 2C, conductive epoxy paste 126 is provided in inlet and outlet openings 120 and 122 and channel 124. Conductive epoxy paste 126 includes silver particles and is dispensed into inlet opening 120 while vacuum suction is applied to outlet opening 122. As a result, conductive epoxy paste 126 flows sequentially through inlet opening 120, channel 124 and outlet opening 122. In other words, conductive epoxy paste 126 enters insulative layer 102 through inlet opening 120 and exits insulative layer 102 through outlet opening 122, thereby filling inlet and outlet openings 120 and 122 and channel 124.

In FIG. 2D, conductive epoxy paste 126 is cured by applying heat, thereby forming electrical trace 104 in inlet and outlet openings 120 and 122 and channel 124.

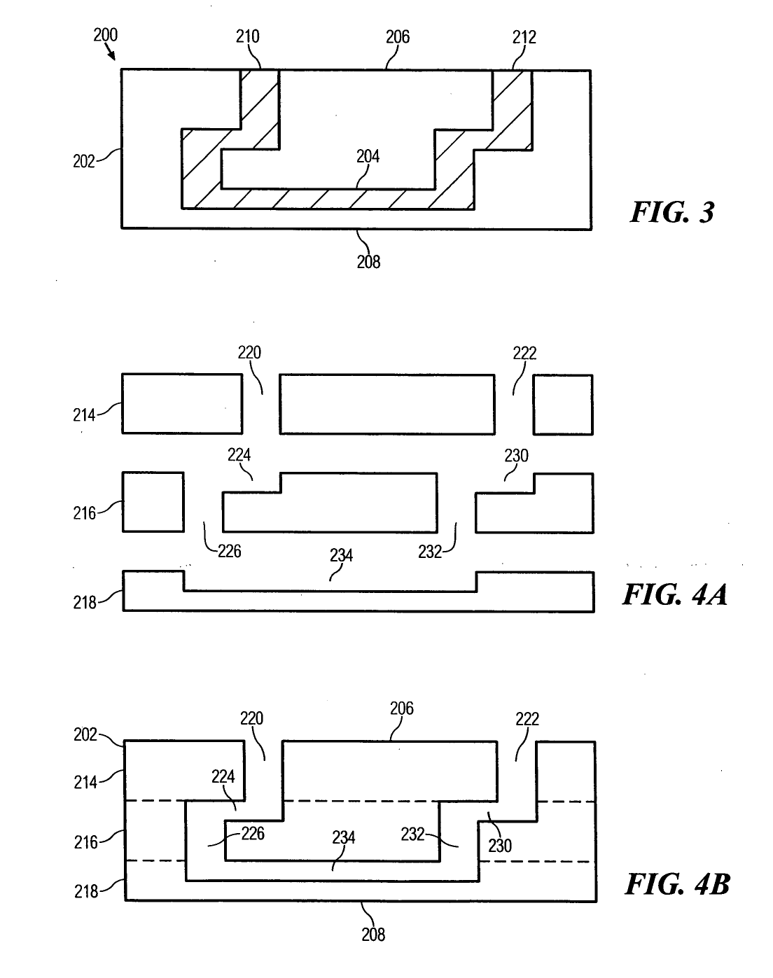

FIG. 3 is a cross-sectional view of electrical interconnect 200 in accordance with a second embodiment of the present invention. Electrical interconnect 200 includes insulative layer 202 and electrical trace 204. Insulative layer 202 is a dielectric layer, and electrical trace 204 is a routing line. Insulative layer 202 includes upper surface 206 and lower surface 208. Electrical trace 204 includes terminals 210 and 212 at upper surface 206. Thus, electrical trace 204 extends into but not through insulative layer 202. Electrical trace 204 electrically connects chips that are subsequently mounted on upper surface 206 and electrically connected to terminals 210 and 212.

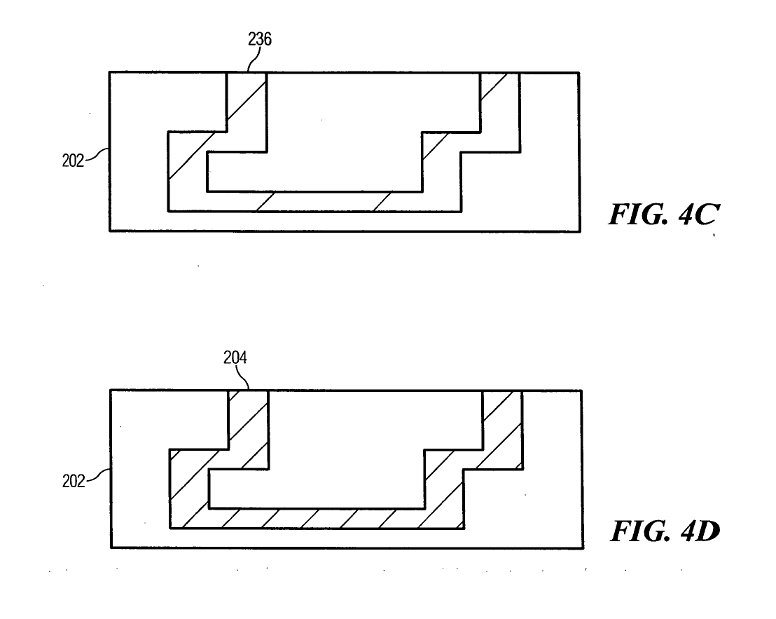

FIGS. 4A-4D are cross-sectional views of a method of making electrical interconnect 200.

In FIG. 4A, upper insulative layer 214, middle insulative layer 216 and lower insulative layer 218 are provided. Upper insulative layer 214 includes inlet opening 220 and outlet opening 222. Inlet and outlet openings 220 and 222 extend through upper insulative layer 214 and are spaced and fluidically separated from one another. Middle insulative layer 216 includes inlet channel 224, inlet via 226, outlet channel 230 and outlet via 232. Inlet and outlet vias 226 and 232 extend through middle insulative layer 216 and are adjacent to and in fluid communication with inlet and outlet channels 224 and 230, respectively. Furthermore, inlet channel and via 224 and 226 are spaced and fluidically separated from outlet channel and via 230 and 232. Lower insulative layer 218 includes channel 234. Insulative layers 214, 216 and 218 are plastic such as PMMA or polycarbonate.

In FIG. 4B, upper insulative layer 214, middle insulative layer 216 and lower insulative layer 218 are bonded to one another using thermal diffusion. Insulative layers 214 and 216 can be bonded together during a first thermal diffusion step and then insulative layers 216 and 218 can be bonded together during a second thermal diffusion step. Alternatively insulative layers 216 and 218 can be bonded together during a first thermal diffusion step and then insulative layers 214 and 216 can be bonded together during a second thermal diffusion step. As another alternative, insulative layers 214 and 216 and insulative layers 216 and 218 can be simultaneously bonded together during a single thermal diffusion step. In every case, middle insulative layer 216 contacts and is sandwiched between upper and lower insulative layers 214 and 218.

Furthermore, inlet and outlet openings 220 and 222 are aligned with inlet and outlet channels 224 and 230, respectively, and inlet and outlet vias 226 and 232 are aligned with opposite ends of channel 234. Thus, inlet and outlet openings 220 and 222, inlet and outlet channels 224 and 230, inlet and outlet vias 226 and 232 and channel 234 are in fluid communication with one another. Furthermore, insulative layers 214, 216 and 218 form insulative layer 202. Thus, upper insulative layer 214 provides upper surface 206, and lower insulative layer 218 provides lower surface 208.

In FIG. 4C, conductive epoxy paste 236 is provided in inlet and outlet openings 220 and 222, inlet and outlet channels 224 and 230, inlet and outlet vias 226 and 232 and channel 234. Conductive epoxy paste 236 includes silver particles and is dispensed into inlet opening 220 while vacuum suction is applied to outlet opening 222. As a result, conductive epoxy paste 236 flows sequentially through inlet opening 220, inlet channel 224, inlet via 226, channel 234, outlet via 232, outlet channel 230 and outlet opening 222. In other words, conductive epoxy paste 236 enters insulative layer 202 through inlet opening 220 and exits insulative layer 202 through outlet opening 222, thereby filling inlet and outlet openings 220 and 222, inlet and outlet channels 224 and 230, inlet and outlet vias 226 and 232 and channel 234.

In FIG. 4D, conductive epoxy paste 236 is cured by applying heat, thereby forming electrical trace 204 in inlet and outlet openings 220 and 222, inlet and outlet channels 224 and 230, inlet and outlet vias 226 and 232 and channel 234.

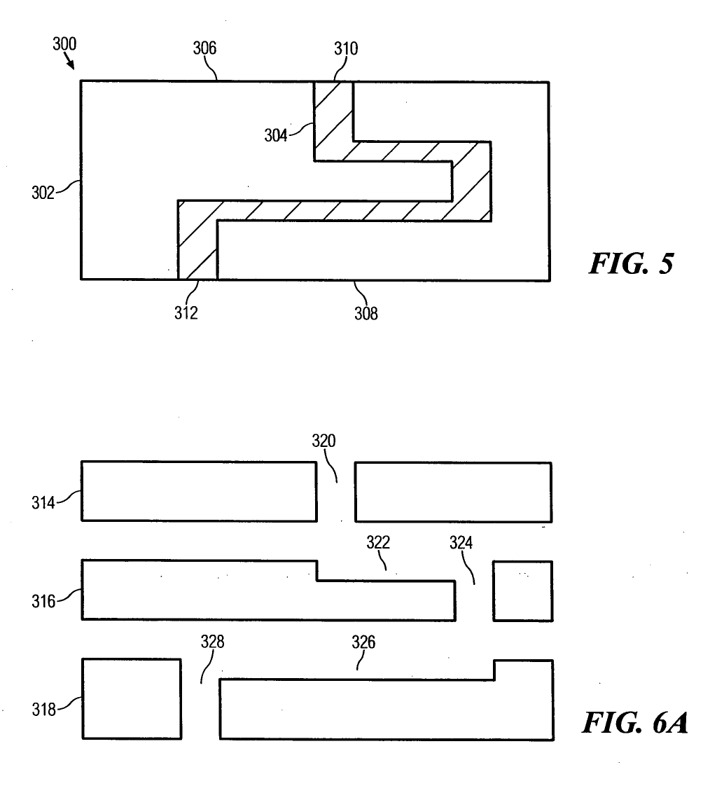

FIG. 5 is a cross-sectional view of microfluidic device 300 in accordance with a third embodiment of the present invention. Microfluidic device 300 includes insulative layer 302 and electrode 304. Insulative layer 302 is a dielectric layer, and electrode 304 is an electric field plate. Insulative layer 302 includes upper surface 306 and lower surface 308. Electrode 304 includes terminal 310 at upper surface 306 and terminal 312 at lower surface 308. Thus, electrode 304 extends through insulative layer 302. Electrode 304 provides an electric field for capacitance measurement during electrophoresis of fluid samples in a capillary (not shown).

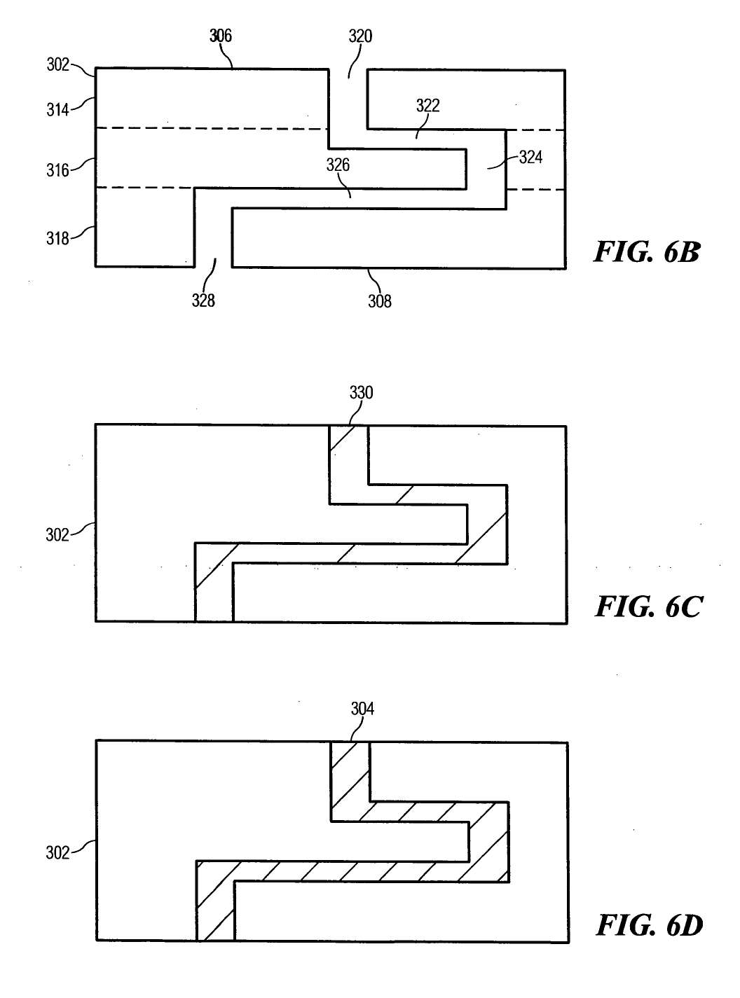

FIGS. 6A-6D are cross-sectional views of a method of making microfluidic device 300.

In FIG. 6A, upper insulative layer 314, middle insulative layer 316 and lower insulative layer 318 are provided. Upper insulative layer 314 includes inlet opening 320 that extends through upper insulative layer 314. Middle insulative layer 316 includes channel 322 and via 324. Via 324 extends through middle insulative layer 316 and is adjacent to and in fluid communication with channel 322. Lower insulative layer 318 includes channel 326 and outlet opening 328. Outlet opening 328 extends through lower insulative layer 318 and is adjacent to and in fluid communication with channel 326. Insulative layers 314, 316 and 318 are plastic such as PMMA or polycarbonate.

In FIG. 6B, upper insulative layer 314, middle insulative layer 316 and lower insulative layer 318 are bonded to one another using thermal diffusion. Insulative layers 314 and 316 can be bonded together during a first thermal diffusion step and then insulative layers 316 and 318 can be bonded together during a second thermal diffusion step. Alternatively insulative layers 316 and 318 can be bonded together during a first thermal diffusion step and then insulative layers 314 and 316 can be bonded together during a second thermal diffusion step. As another alternative, insulative layers 314 and 316 and insulative layers 316 and 318 can be simultaneously bonded together during a single thermal diffusion step. In every case, middle insulative layer 316 contacts and is sandwiched between upper and lower insulative layers 314 and 318.

Furthermore, inlet opening 320 is aligned with channel 322, and outlet opening 328 is aligned with channel 326. Thus, inlet and outlet openings 320 and 328, channels 322 and 326 and via 324 are in fluid communication with one another. Furthermore, insulative layers 314, 316 and 318 form insulative layer 302. Thus, upper insulative layer 314 provides upper surface 306, and lower insulative layer 318 provides lower surface 308.

In FIG. 6C, conductive ink 330 is provided in inlet and outlet openings 320 and 328, channels 322 and 326 and via 324. Conductive ink 330 is water-based and includes silver particles and is dispensed into inlet opening 320 while vacuum suction is applied to outlet opening 328. As a result, conductive ink 330 flows sequentially through inlet opening 320, channel 322, via 324, channel 326 and outlet opening 328. In other words, conductive ink 330 enters insulative layer 302 through inlet opening 320 and exits insulative layer 302 through outlet opening 328, thereby filling inlet and outlet openings 320 and 328, channels 322 and 326 and via 324.

In FIG. 6D, conductive ink 330 is converted from a liquid to a solid by applying heat, thereby forming electrode 304 in inlet and outlet openings 320 and 328, channels 322 and 326 and via 324.

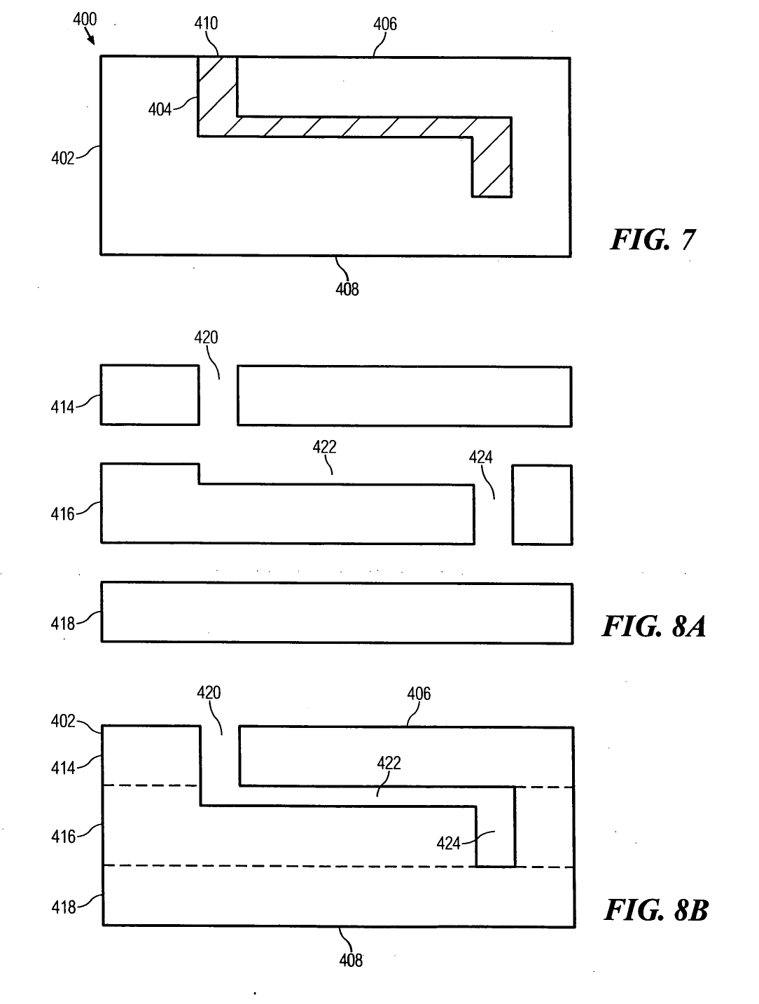

FIG. 7 is a cross-sectional view of microfluidic device 400 in accordance with a fourth embodiment of the present invention. Microfluidic device 400 includes insulative layer 402 and electrode 404. Insulative layer 402 is a dielectric layer, and electrode 404 is an electric field plate. Insulative layer 402 includes upper surface 406 and lower surface 408. Electrode 404 includes terminal 410 at upper surface 406. Thus, electrode 404 extends into but not out of insulative layer 402 and is a dead-end electrode. Electrode 404 provides an electric field for capacitance measurement during electrophoresis of fluid samples in a capillary (not shown).

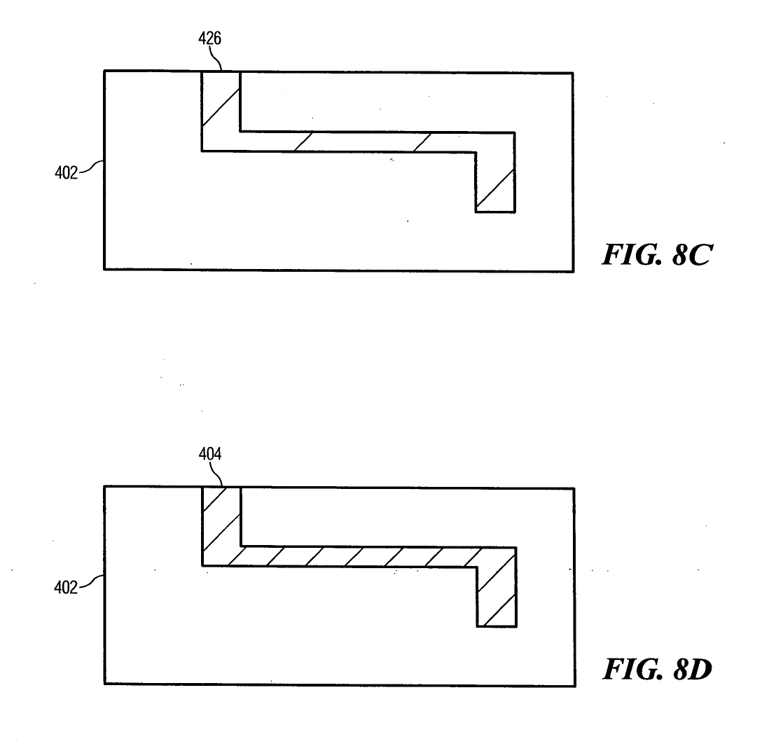

FIGS. 8A-8D are cross-sectional views of a method of making microfluidic device 400.

In FIG. 8A, upper insulative layer 414, middle insulative layer 416 and lower insulative layer 418 are provided. Upper insulative layer 414 includes inlet opening 420 that extends through upper insulative layer 414. Middle insulative layer 416 includes channel 422 and via 424. Via 424 extends through middle insulative layer 416 and is adjacent to and in fluid communication with channel 422. Insulative layers 414, 416 and 418 are plastic such as PMMA or polycarbonate.

In FIG. 8B, upper insulative layer 414, middle insulative layer 416 and lower insulative layer 418 are bonded to one another using thermal diffusion. Insulative layers 414 and 416 can be bonded together during a first thermal diffusion step and then insulative layers 416 and 418 can be bonded together during a second thermal diffusion step. Alternatively insulative layers 416 and 418 can be bonded together during a first thermal diffusion step and then insulative layers 414 and 416 can be bonded together during a second thermal diffusion step. As another alternative, insulative layers 414 and 416 and insulative layers 416 and 418 can be simultaneously bonded together during a single thermal diffusion step. In every case, middle insulative layer 416 contacts and is sandwiched between upper and lower insulative layers 414 and 418.

Furthermore, inlet opening 420 is aligned with channel 422. Thus, inlet opening 420, channel 422 and via 424 are in fluid communication with one another. However, via 424 is sealed by lower insulative layer 418. Furthermore, insulative layers 414, 416 and 418 form insulative layer 402. Thus, upper insulative layer 414 provides upper surface 406, and lower insulative layer 418 provides lower surface 408.

In FIG. 8C, conductive ink 426 is provided in inlet opening 420, channel 422 and via 424. Conductive ink 426 is a water-based liquid that includes silver particles and is dispensed into inlet opening 420 while insulative layer 402 is disposed in a vacuum chamber as the pressure in the vacuum chamber increases from a vacuum to atmospheric pressure. As a result, conductive ink 426 flows sequentially through inlet opening 420, channel 422 and via 424. In other words, conductive ink 426 enters insulative layer 402 through inlet opening 420 but does not exit insulative layer 402, thereby filling inlet opening 420, channel 422 and via 424.

In FIG. 8D, conductive ink 426 is converted from a liquid to a solid by applying heat, thereby forming electrode 404 in inlet opening 420, channel 422 and via 424.

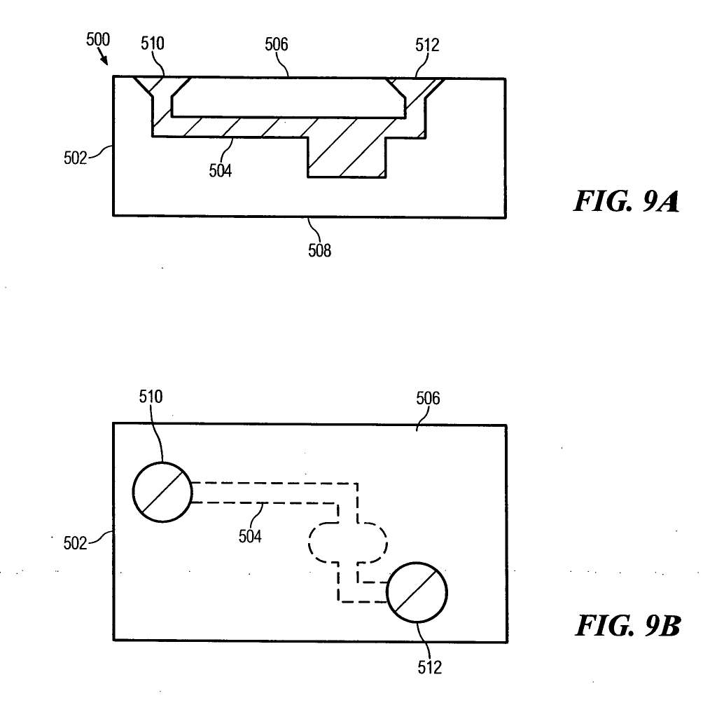

FIGS. 9A and 9B are cross-sectional and top plan views, respectively, of electrical interconnect 500 in accordance with a fifth embodiment in the present invention. Electrical interconnect 500 includes insulative layer 502 and electrical trace 504. Insulative layer 502 is a dielectric layer, and electrical trace 504 is a routing line. Insulative layer 502 includes upper surface 506 and lower surface 508. Electrical trace 504 includes terminals 510 and 512 at upper surface 506. Thus, electrical trace 504 extends into but not through insulative layer 502. Electrical trace 504 between terminals 510 and 512 is buried in insulative layer 502 beneath upper surface 506 and thus is not visible in FIG. 9B, but is shown in FIG. 9B for convenience of illustration. Electrical interconnect 500 can be manufactured in a manner similar to electrical interconnect 200.

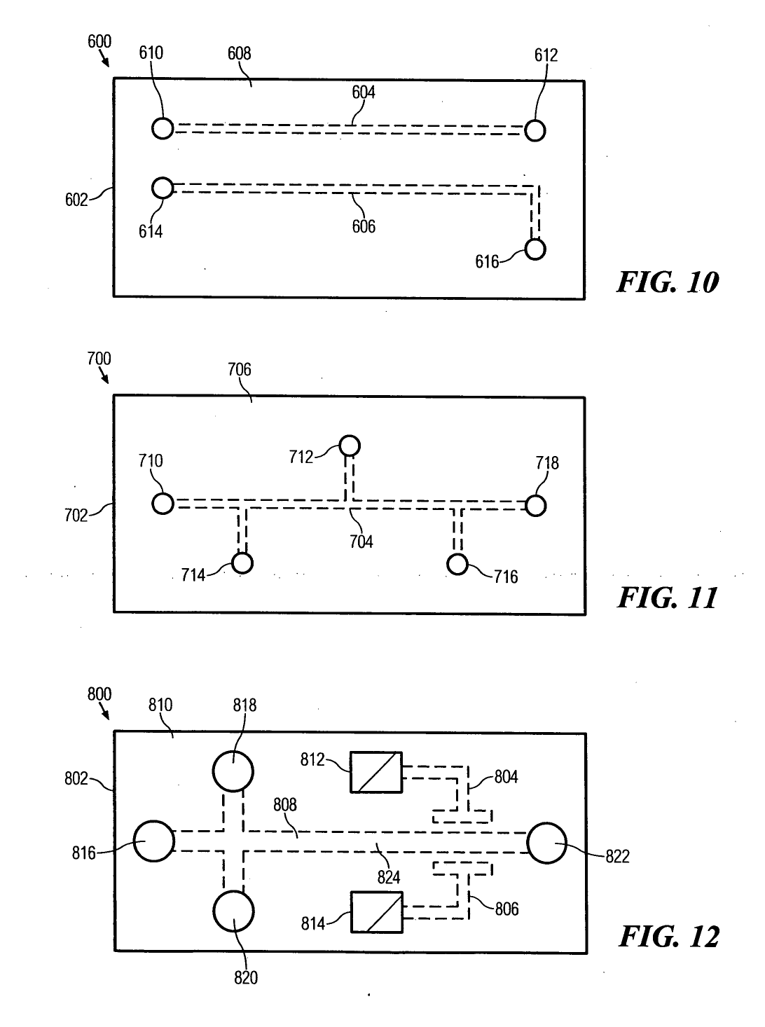

FIG. 10 is a top plan view of electrical interconnect 600 in accordance with a sixth embodiment in the present invention. Electrical interconnect 600 includes insulative layer 602 and electrical traces 604 and 606. Insulative layer 602 is a dielectric layer, and electrical traces 604 and 606 are routing lines. Insulative layer 602 includes upper surface 608 and a lower surface (not shown). Electrical trace 604 includes terminals 610 and 612 at upper surface 608, and electrical trace 606 includes terminals 614 and 616 at upper surface 608. Electrical traces 604 and 606 extend into but not through insulative layer 602. Electrical trace 604 between terminals 610 and 612 is buried in insulative layer 602 beneath upper surface 608 and thus is not visible, but is shown for convenience of illustration. Likewise, electrical trace 606 between terminals 614 and 616 is buried in insulative layer 602 beneath upper surface 608 and thus is not visible, but is shown for convenience of illustration. Electrical interconnect 600 can be manufactured in a manner similar to electrical interconnect 200.

FIG. 11 is a top plan view of electrical interconnect 700 in accordance with a seventh embodiment in the present invention. Electrical interconnect 700 includes insulative layer 702 and electrical trace 704. Insulative layer 702 is a dielectric layer, and electrical trace 704 is a routing line. Insulative layer 702 includes upper surface 706 and a lower surface (not shown). Electrical trace 704 includes terminals 710, 712, 714, 716 and 718 at upper surface 706. Electrical trace 704 extends into but not through insulative layer 702. Electrical trace 704 between terminals 710, 712, 714, 716 and 718 is buried in insulative layer 702 beneath upper surface 706 and is thus not visible, but is shown for convenience of illustration. Electrical interconnect 700 can be manufactured in a manner similar to electrical interconnect 200.

FIG. 12 is a top plan view of microfluidic device 800 in accordance with an eighth embodiment of the present invention. Microfluidic device 800 includes insulative layer 802, electrodes 804 and 806 and capillary 808. Insulative layer 802 is a dielectric layer, and electrodes 804 and 806 are electric field plates. Insulative layer 802 includes upper surface 810 and a lower surface (not shown). Electrodes 804 and 806 include terminals 812 and 814, respectively, at upper surface 810. Electrodes 804 and 806 extend into but not through insulative layer 802 and are dead-end electrodes that each contain a single exposed terminal. Electrodes 804 and 806 are electrically connected to circuitry that is subsequently bonded to terminals 812 and 814, respectively, at upper surface 810. Capillary 808 includes inlet openings 816 and 818, outlet openings 820 and 822 and channel 824 which are in fluid communication with one another. Samples enter inlet openings 816 and 818 and flow into channel 824, flow through channel 824 to outlet openings 820 and 822, and then exit through outlet openings 820 and 822. Electrodes 806 and 808 provide capacitance measurement for the fluid samples in channel 824 flowing to outlet opening 822. Electrode 806 from terminal 812 to its T-shaped end near channel 824 is buried in insulative layer 802 beneath upper surface 810 and thus is not visible, but is shown for convenience of illustration. Likewise, electrode 808 from terminal 814 to its T-shaped end near channel 824 is buried in insulative layer 802 beneath upper surface 810 and thus is not visible, but is shown for convenience of illustration. Similarly, capillary 808 between openings 816, 818, 820 and 822 is buried in insulative layer 802 beneath upper surface 810 and thus is not visible, but is shown for convenience of illustration. Microfluidic device 800 can be manufactured in a manner similar to microfluidic device 400.

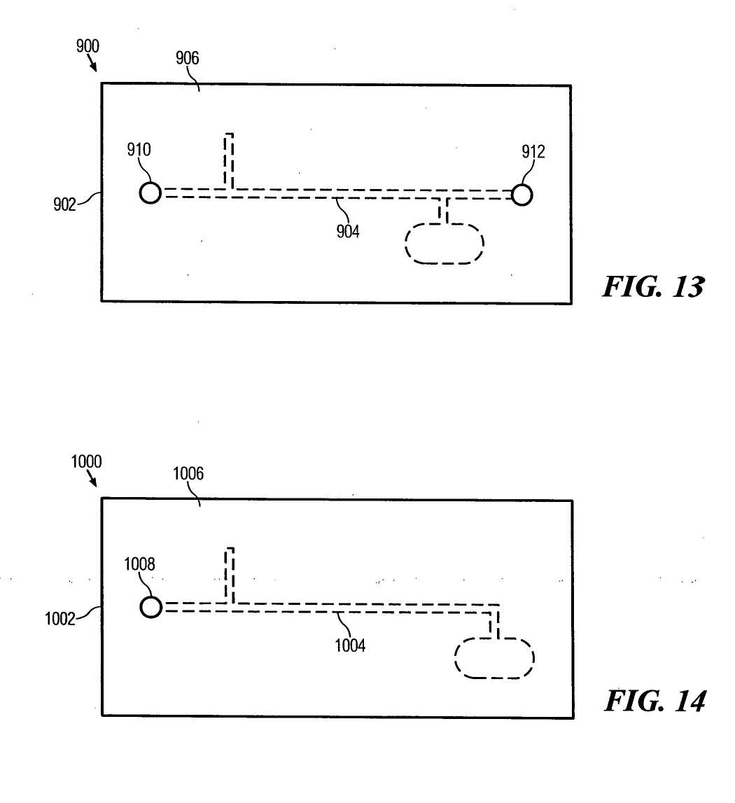

FIG. 13 is a top plan view of microfluidic device 900 in accordance with a ninth embodiment in the present invention. Microfluidic device 900 includes insulative layer 902 and electrode 904. Insulative layer 902 is a dielectric layer, and electrode 904 is an electric field plate. Insulative layer 902 includes upper surface 906 and a lower surface (not shown). Electrode 904 includes terminals 910 and 912 at upper surface 906. Electrode 904 extends into but not through insulative layer 902. Electrode 904 between terminals 910 and 912 is buried in insulative layer 902 beneath upper surface 906 and thus is not visible, but is shown for convenience of illustration. Microfluidic device 900 can be manufactured in a manner similar to microfluidic device 300.

FIG. 14 is a top plan view of microfluidic device 1000 in accordance with a tenth embodiment in the present invention. Microfluidic device 1000 includes insulative layer 1002 and electrode 1004. Insulative layer 1002 is a dielectric layer, and electrode 1004 is an electric field plate. Insulative layer 1002 includes upper surface 1006 and a lower surface (not shown). Electrode 1004 includes terminal 1008 at upper surface 1006. Electrode 1004 extends into but not through insulative layer 1002 and is a dead-end electrode that contains a single exposed terminal. Electrode 1004 from terminal 1008 is buried in insulative layer 1002 beneath upper surface 1006 and thus is not visible, but is shown for convenience of illustration. Microfluidic device 1000 can be manufactured in a manner similar to microfluidic device 400.

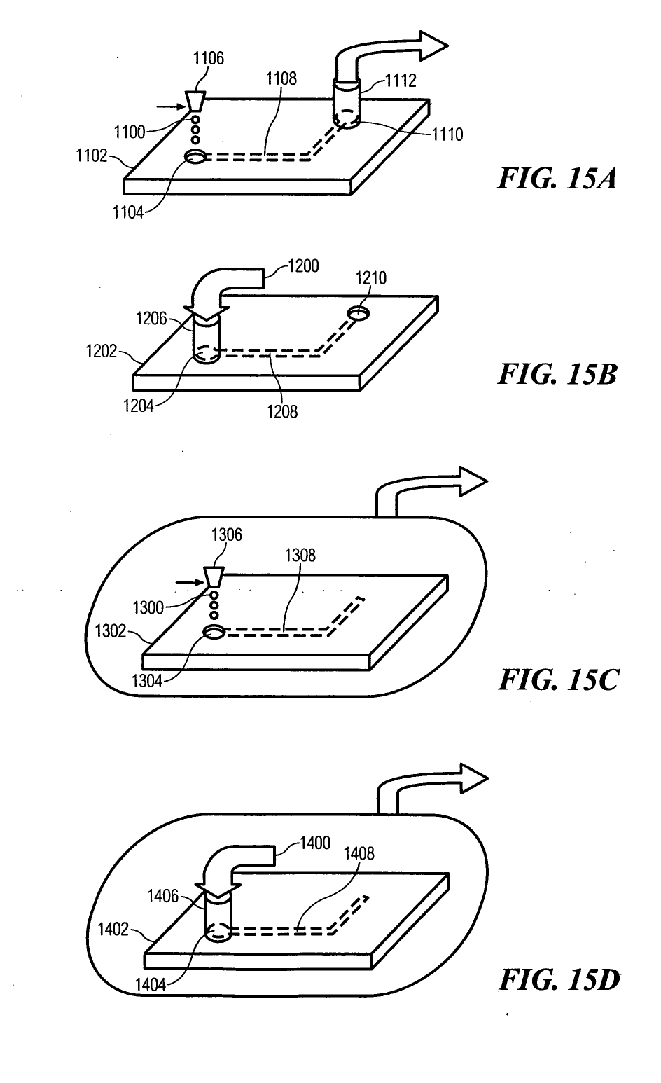

FIGS. 15A-15D are perspective views of techniques for flowing a non-solidified material into an insulative layer to subsequently provide embedded metallization in the insulative layer in accordance with the present invention.

In FIG. 15A, non-solidified material 1100 is dispensed into insulative layer 1102 at inlet opening 1104 by dispense nozzle 1106, flows through channel 1108 and exits insulative layer 1102 at outlet opening 1110 into vacuum suction device 1112. Thus, non-solidified material 1100 flows into and out of insulative layer 1102 in response to vacuum suction. Dispense nozzle 1106 is spaced from insulative layer 1102 and aligned with inlet opening 1104, and vacuum suction device 1112 contacts insulative layer 1102 and covers and applies vacuum suction to outlet opening 1110.

In FIG. 15B, non-solidified material 1200 is dispensed into insulative layer 1202 at inlet opening 1204 by injection nozzle 1206, flows through channel 1208 and exits insulative layer 1202 at outlet opening 1210. Thus, non-solidified material 1200 flows into and out of insulative layer 1202 in response to pressurized injection. Injection nozzle 1206 contacts insulative layer 1202 and covers and applies pressurized injection at inlet opening 1204.

In FIG. 15C, non-solidified material 1300 is dispensed into insulative layer 1302 at inlet opening 1304 by dispense nozzle 1306, flows into channel 1308 and eventually fills inlet opening 1304 and channel 1308. Thus, non-solidified material 1300 flows into but not out of insulative layer 1302. Furthermore, insulative layer 1302 is disposed in a vacuum chamber as non-solidified material 1300 flows into insulative layer 1302. Initially, the vacuum chamber is evacuated, thereby creating a vacuum in inlet opening 1304 and channel 1308. Thereafter, non-solidified material 1300 is continually dispensed into inlet opening 1304 as the vacuum chamber pressure is elevated from the vacuum to atmospheric pressure. As a result, there is little or no pressure front between the leading edge of non-solidified material 1300 and the dead-end in channel 1308 as non-solidified material 1300 flows towards and eventually contacts the dead-end. Furthermore, the pressure increase at inlet opening 1304 ensures that non-solidified material 1300 flows into and fills inlet opening 1304 and channel 1308. This technique is particularly well-suited for filling dead-end channels and vias with non-solidified material that is subsequently converted to a dead-end electrode.

In FIG. 15D, non-solidified material 1400 is dispensed into insulative layer 1402 at inlet opening 1404 by injection nozzle 1406, flows into channel 1408 and eventually fills inlet opening 1404 and channel 1408. Thus, non-solidified material 1400 flows into but not out of insulative layer 1402. Furthermore, insulative layer 1402 is disposed in a vacuum chamber as non-solidified material 1400 flows into insulative layer 1402. Initially, the vacuum chamber is evacuated, thereby creating a vacuum in inlet opening 1404 and channel 1408. Thereafter, injection nozzle 1406 contacts insulative layer 1402 and covers inlet opening 1404. Next, non-solidified material 1400 is continually pressure injected into inlet opening 1404 as the vacuum chamber retains the vacuum. Alternatively, non-solidified material 1400 is continually pressure injected into inlet opening 1404 as the vacuum chamber pressure is elevated from the vacuum to atmospheric pressure. Furthermore, a syringe that contains injection nozzle 1406 and a piston (not shown) is disposed in the vacuum chamber, and the pressure increase at the piston (but not in channel 1408) facilitates flowing non-solidified material 1400 through inlet opening 1404 into channel 1408. In either case, since channel 1408 contains the vacuum as non-solidified material 1400 flows into channel 1408, there is little or no pressure front between the leading edge of non-solidified material 1400 and the dead-end in channel 1408 as non-solidified material 1400 flows towards and eventually contacts the dead-end. This technique is particularly well-suited for filling dead-end channels and vias with non-solidified material that is subsequently converted to a dead-end electrode.

The present invention is well-suited for manufacturing multilayer substrates with embedded metallization such as electrical traces and electrodes for microfluidic devices, electrical interconnects, display panels, EMI shields, antennas and other electronic devices that contain three-dimensional embedded metallization.

The insulative layer can be the upper and lower insulative layers, or include the upper and lower insulative layers and one or more middle insulative layers therebetween. The upper and lower insulative layers and the middle insulative layer(s) (if any) can each include various channels and/or vias in fluid communication with one another. In addition, the upper and lower insulative layers and the middle insulative layer(s) (if any) can be a wide variety of electrically insulative materials such as plastic, ceramic and composites and can be bonded together in numerous ways including thermal diffusion and thin intervening patterned adhesive layers. Likewise, the channels and vias can have numerous shapes and sizes. For instance, a dead-end via for a dead-end electrode can be formed by a through via that extends through the middle insulative layer and is sealed by the lower insulative layer, or a blind via that extends into but not through the lower insulative layer.

The above description and examples illustrate embodiments of the present invention, and it will be appreciated that various modifications and improvements can be made without departing from the scope of the present invention.

1. A method of making a substrate, comprising:
providing an upper insulative layer and a lower insulative layer, wherein the upper insulative layer includes an inlet opening, the lower insulative layer includes a channel, and the inlet opening is in fluid communication with the channel;
flowing a non-solidified material through the inlet opening into the channel; and then
solidifying the non-solidified material by applying energy to the non-solidified material, thereby forming embedded metallization in the channel.

2. The method of claim 1, including providing a middle insulative layer that is sandwiched between the upper and lower insulative layers, wherein the middle insulative layer includes a via between and in fluid communication with the inlet opening and the channel.

3. The method of claim 2, including bonding the upper insulative layer to the middle insulative layer using thermal diffusion, and bonding the middle insulative layer to the lower insulative layer using thermal diffusion.

4. The method of claim 2, including bonding the upper insulative layer to the middle insulative layer using an upper adhesive layer that contacts and is sandwiched between the upper and middle insulative layers, and bonding the middle insulative layer to the lower insulative layer using a lower adhesive layer that contacts and is sandwiched between the middle and lower insulative layers.

5. The method of claim 1, including flowing the non-solidified material using pressure injection or vacuum suction.

6. (canceled)

7. The method of claim 1, including flowing the non-solidified material through the channel into an outlet opening in the upper insulative layer.

8-15. (canceled)

16. The method of claim 1, wherein the embedded metallization fills the channel or forms a tube in the channel.

17-20. (canceled)

21. A method of making a substrate, comprising:
providing an insulative layer that includes an upper insulative layer and a lower insulative layer, wherein the upper insulative layer includes an inlet opening, the lower insulative layer includes a channel, and the inlet opening and the channel are in fluid communication with one another but not with an outlet opening;
disposing the insulative layer in a vacuum chamber;
evacuating the vacuum chamber, thereby creating a vacuum in the inlet opening and the channel; then
flowing a non-solidified material into the inlet opening while the vacuum chamber contains the vacuum and then through the inlet opening into the channel while the insulative layer remains in the vacuum chamber, thereby flowing the non-solidified material into but not out of the insulative layer; and then
solidifying the non-solidified material by applying energy to the non-solidified material, thereby forming a dead-end electrode in the channel.

22. The method of claim 21, including flowing the non-solidified material through the inlet opening into the channel while pressure in the vacuum chamber remains the vacuum or while pressure in the vacuum chamber increases from the vacuum to a predetermined pressure.

23. (canceled)

24. The method of claim 21, wherein the insulative layer is the upper and lower insulative layers.

25. The method of claim 21, wherein the insulative layer includes the upper and lower insulative layers and a middle insulative layer that is sandwiched between the upper and lower insulative layers, and the middle insulative layer includes a via between and in fluid communication with the inlet opening and the channel.

26-27. (canceled)

28. The method of claim 21, wherein the dead-end electrode fills the channel or both the inlet opening and the channel.

29-30. (canceled)

31. A method of making a microfluidic device, comprising:
providing an upper insulative layer, a middle insulative layer and a lower insulative layer, wherein the upper insulative layer includes an inlet opening, the middle insulative layer includes a via, the lower insulative layer includes a channel, and the inlet opening, the via and the channel are in fluid communication with one another; then
flowing a non-solidified material sequentially through the inlet opening, the via and the channel; and then
solidifying the non-solidified material by applying energy to the non-solidified material, thereby forming embedded metallization that provides an electrode in the inlet opening, the via and the channel.

32. The method of claim 31, including providing the top, middle and lower insulative layers with the inlet opening, the via and the channel; then bonding the upper insulative layer to the middle insulative layer; and bonding the middle insulative layer to the lower insulative layer.

33. The method of claim 31, including flowing the non-solidified material using pressure injection at the inlet opening or using vacuum suction at an outlet opening in the insulative layer.

34-38. (canceled)

39. The method of claim 31, wherein the electrode fills the channel or a combination of the inlet opening, the via and the channel.

40. (canceled)

41. A method of making an electrical interconnect, comprising:
providing an upper insulative layer, a middle insulative layer and a lower insulative layer, wherein the upper insulative layer includes an inlet opening and an outlet opening, the middle insulative layer includes an inlet via and an outlet via, the lower insulative layer includes a channel, and the inlet and outlet openings, the inlet and outlet vias and the channel are in fluid communication with one another; then
flowing a non-solidified material sequentially through the inlet opening, the inlet via, the channel, the outlet via and the outlet opening; and then
solidifying the non-solidified material by applying energy to the non-solidified material, thereby forming embedded metallization that provides an electrical trace in the inlet and outlet openings, the inlet and outlet vias and the channel.

42. The method of claim 41, including providing the top, middle and lower insulative layers with the inlet and outlet openings, the inlet and outlet vias and the channel; then bonding the upper insulative layer to the middle insulative layer; and bonding the middle insulative layer to the lower insulative layer.

43. The method of claim 41, including flowing the non-solidified material using pressure injection at the inlet opening or using vacuum suction at the outlet opening.

44-48. (canceled)

49. The method of claim 41, wherein the electrical trace fills the channel or a combination of the inlet and outlet openings, the inlet and outlet vias and the channel.

50. (canceled)
